(19) United States
(12) Patent Application Publication
(10) Pub. No.: US 2017/0183157 A9
(43) Pub. Date: Jun. 29, 2017

(54) ROBOTIC MANIPULATOR FOR WAREHOUSES

(71) Applicant: Kent Massey, Bryn Mawr, PA (US)

(72) Inventor: Kent Massey, Bryn Mawr, PA (US)

(73) Assignee: HDT ROBOTICS, INC., Fredericksburg, VA (US)

(21) Appl. No.: 14/306,400

(22) Filed: Jun. 17, 2014

Related U.S. Application Data
(60) Provisional application No. 61/836,223, filed on Jun. 18, 2013.

(51) Int. Cl. B65G 1/137

(52) U.S. Cl. CPC B65G 1/1373

(57) ABSTRACT

A warehouse robotic system includes a picker robot, including a mobile base, an environment sensing system, a communications system and at least one manipulator. The picker robot can also include an object sensing system. The robotic system also includes a control system, including a communications system and a robot controller which communicates with the picker robot and is connected to an associated warehouse inventory system. The picker robot is adapted to maneuver to a first location, retrieve at least one associated object from the first location, transport the at least one associated object to a second location and place the at least one associated object at the second location. The system can also include a carrier robot and a storage container.

### BACKGROUND

The present exemplary embodiment relates generally to robotics. It finds particular application in conjunction with warehouse management, and will be described with particular reference thereto. However, it is to be appreciated that the present exemplary embodiment is also amenable to other like applications.

Workers in many non-automated warehouses and distribution centers spend the majority of their day walking or driving up and down aisles to find the location of products or packages meant for retrieval. The amount of time that a worker spends actually placing or removing objects from shelves can account for only a small portion of the labor hours expended during the worker's typical day. The vast majority of warehouses do not make significant use of robotic manipulators.

In a typical warehouse material flow, a pallet will leave a manufacturer with a ‘unit-load’ of objects, all of which are identical. These objects can be sealed, rectangular cardboard boxes, or a plastic-wrapped flat of beverages, or other self-contained groupings of items. These objects are usually referred to as ‘cases’. Each case generally contains multiple cartons or other packaged groupings of items that are intended for individual sale. Unit-load pallets can also be made up of sealed bags of loose material, such as dog food or the like.

According to one aspect of warehouse operations, a unit load pallet is placed into storage until it is retrieved and sent out. A more complex aspect of warehouse operations is breaking open the unit load pallets and reassembling a variety of cases from different pallets, containing different products, together on a single pallet, which is often called a mixed case pallet. Distribution warehouses that supply large retail stores often assemble mixed case pallet loads for shipment to individual stores. Such mixed case pallet loads are generally built up manually by workers who walk or drive the warehouse aisles with a pallet mover and physically transfer cases from the stored unit load pallets to the mixed case pallet located on the pallet mover. Because cases on unit load pallets are stacked to the height of an average person and higher, workers only pick cases from the unit load pallets located at floor level. Unit load pallets located on higher shelves are stored for future use. Forklifts are generally required to move these pallets from one location to another, such as to a lower shelf for access by a worker.

An even more complex warehouse operation is opening cases and assembling individual cartons together from one or more cases for shipment to an individual customer. An example of this type of open case operation is an internet-based fulfillment center. Open case picking is sometimes called split case picking, broken case picking, piece picking, or each picking.

There are a variety of strategies for labor optimization in picking operations, including batch picking, zone picking, and wave picking. All of these solutions work best in large, high-volume operations and generally require some capital-intensive materials-handling equipment. To implement these strategies, the warehouse or distribution center generally needs to be completely redesigned and reorganized.

More highly automated solutions for open case operations usually involve an automated mechanism that brings cartons in a movable storage unit to a human operator, who removes the desired item (i.e., an individual carton). These items are then packed in boxes for shipment to fulfill the order. As new unit load pallets and whole cases come in, other operators place cartons from newly opened cases in movable storage units. An automated system keeps track of the content of all of the storage units, the location of all the storage units, and then moves each storage unit to where it needs to be.

These highly automated solutions are very expensive. They also require the interior of the building to be stripped back to a bare concrete floor. Unique storage systems and autonomous material transport systems must then be installed. Finally, all of the inventory must be loaded into the system. Because this level of rework is extremely disruptive to any existing operations, highly automated systems are generally only installed in new facilities.

Automated systems also exist for handling cases and assembling mixed case pallets. These automated systems generally group a small set of cases onto a carrier that is placed into a storage system using a series of elevators and conveyors. The carriers are then retrieved through the system when one or more of the cases is needed to assemble a mixed case pallet.

There are also other known systems employed to enhance the efficiency of warehouses. However, the types of systems outlined in detail above are the most germane to the present disclosure.

There are four major categories of tasks performed in open case picking operations: 1) mobility—moving from location to location; 2) information processing—deciding what needs to be picked, based on customer orders; 3) visual processing—scanning the environment to locate the carton that needs to be picked; and 4) manipulation—picking up the carton and placing it in a package for shipment to the customer.

Automation efforts have primarily focused on improving efficiency in the performance of the first two tasks: mobility and information processing. For the third task of visual processing, some work has been done using light-based cueing to assist workers. For the fourth task of manipulation, almost no products are available, primarily because it is very difficult for any robotic device to match the speed and dexterity of people. Only with the issue of lifting heavy objects has some limited work been done in developing manipulation assist devices.

The present application provides a new and improved system and method which overcome the above-referenced problems and others.

### BRIEF SUMMARY

In accordance with one aspect of the present disclosure, a warehouse robotic system comprises a picker robot which includes a mobile base, an environment sensing system, a communications system, at least one manipulator and an object sensing system. A control system includes a communications system which communicates with an associated warehouse inventory system and a robot controller, wherein the picker robot is adapted to maneuver to a first location, retrieve an associated at least one object from such first location, transport the associated at least one object to a second location and place the associated at least one object at the second location.

In accordance with another embodiment of the present disclosure, there is provided a warehouse robotic system, including a picker robot comprising a mobile base, an environment sensing system, a communications system, at least one manipulator, and an object sensing system. A control system includes a communications system, a robot controller and a central control system which communicates with an associated warehouse inventory system. A storage container is provided with identification features. The picker robot is adapted to maneuver to a first location, identify the storage container, retrieve the storage container from the first location, transport the storage container to a second location and place the storage container at that second location.

In accordance with still another aspect of the present disclosure, there is provided a warehouse robotic system, including a picker robot comprising a mobile base, an environment sensing system, a communications system, at least one manipulator. The warehouse robotic system further includes a carrier robot comprising a mobile base, an environment sensing system and a communications system. The warehouse robotic system further includes a control system which communicates with the picker robot and the carrier robot. A robot controller on each of the picker robot and the carrier robot communicates with an associated warehouse inventory system. The warehouse robot system further comprises a storage container. The picker robot is adapted to maneuver to a first location and retrieve the storage container from the first location. The picker robot is adapted to place the storage container on the carrier robot and the carrier robot is adapted to transport the storage container to a second location. The carrier robot is adapted to return the storage container to the picker robot which is adapted to place the storage container back into the first location.

In accordance with still another aspect of the present disclosure, there is provided a warehouse robotic system, including a picker robot comprising a mobile base, an environment sensing system, a communications system, and at least one manipulator. The warehouse robotic system further includes a carrier robot comprising a mobile base, an environment sensing system and a communications system. The warehouse robotic system further includes a control system which communicates with the picker robot and the carrier robot. A robot controller on each of the picker robot and the carrier robot communicates with an associated warehouse inventory system. The picker robot is adapted to maneuver to a first location. The picker robot is adapted to retrieve an associated at least one object from such first location and to place the at least one object on the carrier robot and the carrier robot is adapted to transport the at least one object to a second location.

### BRIEF DESCRIPTION OF THE DRAWINGS

Illustrated in the accompanying drawings are several embodiments of the present disclosure.

FIG. 1 is a schematic perspective view of a picker robot according to a first embodiment of the present disclosure;

FIG. 2 is a schematic perspective view of a picker robot according to a second embodiment of the present disclosure;

FIG. 3 is a schematic perspective view of a carrier robot according to one embodiment of the present disclosure;

FIG. 4 is a schematic view of a control system for operating a warehouse robotic system employing a picker robot as shown in FIGS. 1 and 2 and a carrier robot as shown in FIG. 3 according to the present disclosure;

FIG. 5 is a schematic perspective view of a storage container or tote which can be employed with the warehouse robotic system of the present disclosure; and

FIG. 6 illustrates a general purpose computer which can be part of a work station that is situated at a remote location from the picker robots shown in FIGS. 1 and 2 and the carrier robot shown in FIG. 3 so that these robots can be remotely operated by a human.

### DETAILED DESCRIPTION

The present application discloses a system that can increase labor productivity by allowing one or more human operators to selectively and remotely control a fleet of robotic mobile devices that can pick and place cases, as well as transport them. Transport tasks are performed mostly autonomously, whereas picking and packing tasks can be performed either autonomously or at the direction of a human operator as may be desired. In that regard, the human operator can remotely control the placement and removal of objects, products or merchandise using a sensor system including a camera, and using a manipulator system mounted to the robot. In one embodiment, the manipulator system includes a manipulator that can be in the form of a limb, such as an arm, comprising one or several segments with movable digits.

Because many robotic mobile devices can be functioning simultaneously, when the human operator has finished one placement or removal task, another robotic mobile device can be in position for the next placement or removal task. In this way, the human operator can spend as much time as possible performing visual processing tasks using remote cameras and manipulation tasks using remote manipulator systems. Humans are still greatly superior to robots as to both tasks. The system could autonomously perform almost all of the mobility and information processing tasks.

In some embodiments, once the human operator has succeeded in grasping a case or pallet with a robotic device and lifting it sufficiently clear of other cases or pallets, the operator could return control to the robotic mobile device, which will autonomously place the case on/in the appropriate carrying area of the same or another robotic mobile device.

Picked cases can be brought to assembly areas where human employees either pick individual products or cartons from the case for aggregation into shipments to fulfill orders, or the employees could place the entire case on a pallet to build up a custom pallet load. In connection with open-case, piece-picking operations, the partially full cases will be returned to the warehouse storage area where the case will be placed on a shelf (i.e., packed).

The mobility task of moving goods from storage areas to assembly areas is often the most expensive part of warehouse and distribution center operations. For non-automated facilities, the expense is due to the amount of labor hours required to move goods from location to location. In automated facilities, the expense is due to the high cost of autonomous material handling systems. The robotic mobile devices described herein have the benefit of being able to operate in current, non-automated facilities, without any infrastructure improvements or the need for extensive retrofits.

As autonomous robotic capabilities improve in visual processing and manipulation tasks, the mobile devices can be upgraded to perform more of these tasks, leaving the human operator to remotely control only the more difficult placement and removal operations that are beyond the ability of the autonomous system. With this increase in autonomous capability, the number of robotic mobile devices that a single human operator can control could increase. At some point, all or nearly all such operations will be autonomous.

In ordinary operations of the robotic mobile device, a central processing system will take in orders and determine the most efficient tasking of the mobile device to maneuver through the facility to the locations where the cases are stored that are needed to fill the order or orders. When an individual robotic mobile device reaches its commanded location, it will deploy its sensors and manipulators in a ready configuration that is near the case to be picked. As sensors and visual processing become more robust, the sensors and manipulators will be deployed closer to the case, in a more optimal ready configuration, so that the human operator needs to spend the minimal amount of time grasping the storage unit. Eventually, a human operator will not be needed for grasping most cases.

The foregoing presupposed a common robotic device for both transport tasks and picking/packing tasks. However, in other embodiments of the present disclosure, a plurality of robot types can be employed, including one robot type that is primarily a picker and another robot type that is primarily a carrier. A picker robot could be equipped with sensors, at least one manipulator, and communications capabilities, so that it can place and retrieve cases on shelves. A carrier robot would be less expensive and limited to carrying cases that are placed on it from one location to another. The benefit of this division of tasks is that the less expensive carrier robots are used for the time-consuming task of mobility, while the more expensive picker robots are used for visual perception and manipulation, as directed for at least part of the time by a remote human operator. In one embodiment, there can be a plurality of carrier robots for each picker robot.

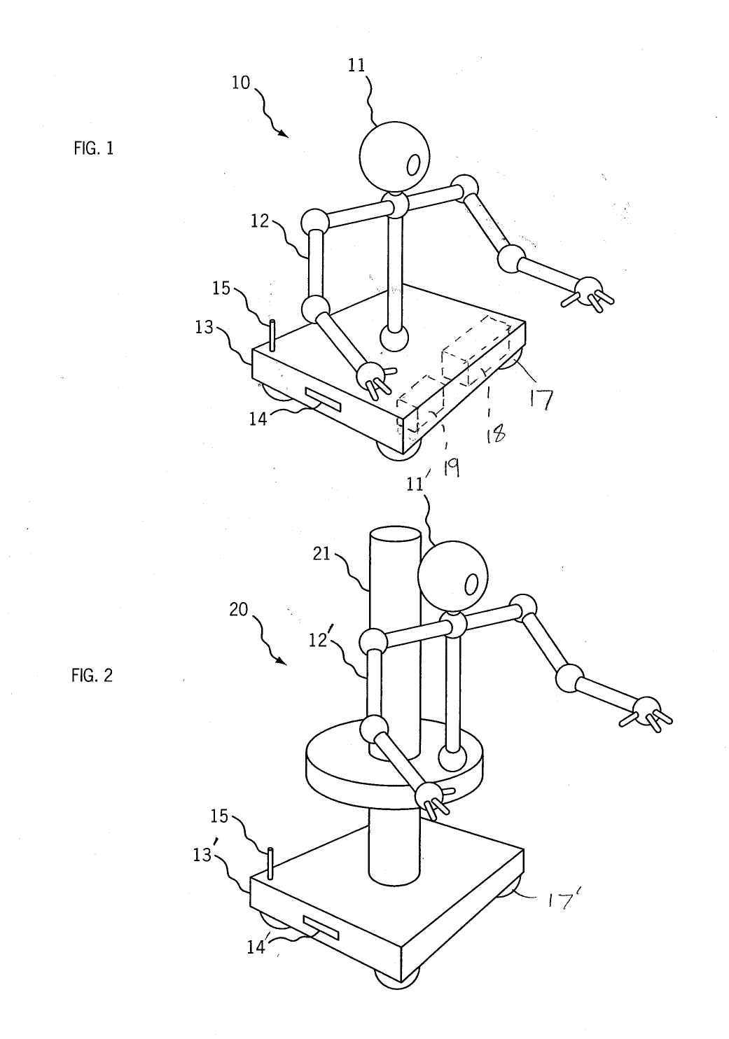

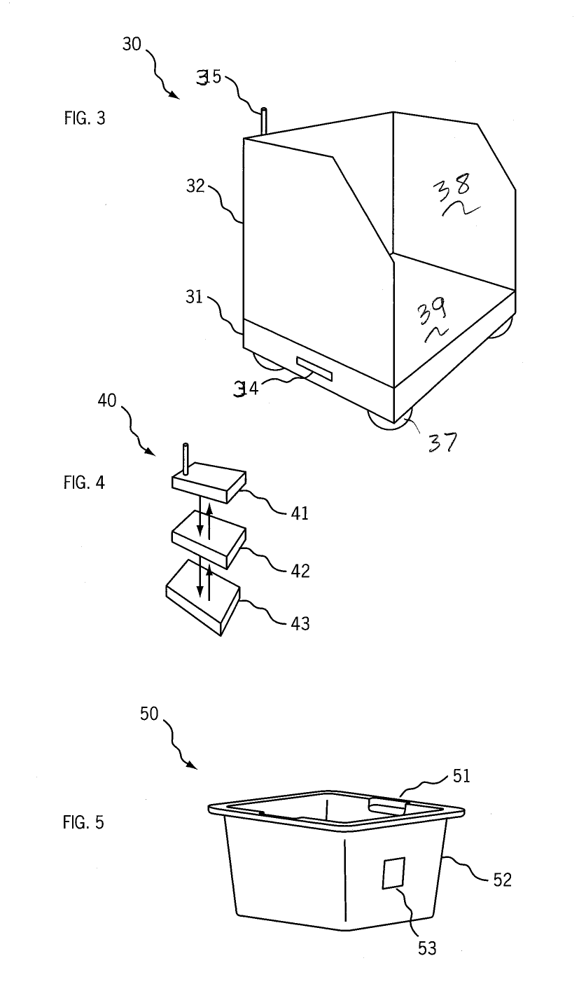

With reference now to FIG. 1, a picker robot 10 according to one embodiment of the present disclosure includes a mobile base 13 on which are mounted one or more manipulators 12. To this end, the base is provided with one or more wheels 17, casters or other means for allowing the base to move, such as treads or the like. A motor 18 can be disposed in the base 13 for driving the wheels, etc. In the embodiment disclosed, two such spaced manipulators 12 are shown. Each manipulator can comprise a plurality of segments which are movable in relation to each other and which terminate in digits that are themselves movable. Modular robotic limbs are disclosed in U.S. Pat. No. 8,425,620 dated Apr. 23, 2013 and in U.S. Patent Publication No. 2012/0286629 dated Nov. 15, 2012. Movable digits for robotic manipulators are disclosed in U.S. Pat. No. 8,470,051 dated Jun. 25, 2013. The subject matter of each of these publications is incorporated hereinto in its entirety.

With further reference to FIG. 1, the mobile base 13 of the picker robot 10 can maneuver through a warehouse to different storage locations. An environment sensing system 14 can be mounted on or to the base 13. The environment sensing system 14 helps the picker robot 10 to accurately maneuver to the correct location while avoiding obstacles and people. In one embodiment, the environment sensing system can employ light detection and ranging (LIDAR) technologies which are useful for driverless vehicles. Such environment sensing systems are available from Hokuyo Automatic Co. Ltd. of Osaka, Japan; SICK AG of Waldkirch, Germany; or Velodyne of Morgan Hill, Calif. Each of these companies provides such LIDAR sensing systems. The picker robot 10 can also be provided with a communications system 15 which connects the robot to a control system 40 as illustrated in FIG. 4. The communications system 15 can employ many different known technologies. For example, 802.11 Wi-Fi radios can be employed for this purpose.

Mounted on the picker robot 10 are one or more manipulators 12 which are used to grasp, lift and place objects, such as storage containers 50 illustrated in FIG. 5. Two spaced manipulators 12 are shown in FIG. 1. Also mounted on the picker robot is an object sensing system 11 which helps identify the objects and storage containers 50 that the picker robot 10 has been tasked with manipulating by the control system 40. The object sensing system 11 may share all, part or none of its components with the environment sensing system 14. In one embodiment, the object sensing system 11 can be similar to the Microsoft Kinect type device. These systems can employ an infrared projector and camera and a special microchip to track the movement of objects or individuals in three-dimensions. Other such systems are also known. For example, a known system employs a depth sensor consisting of an infrared laser projector combined with a monochrome CMOS sensor which captures video data in 3D under any ambient light conditions. Similar stereo optical sensing systems are also known in the art.

Electrical power for the picker robot 10, including the object sensing system 11, the one or more manipulators 12, environment sensing system 14 and the communications system 15 can be provided by suitable known batteries 19, which can be housed in the mobile base 13. The batteries also power the motor 18 which drives the wheels or other means that allow the base to move.

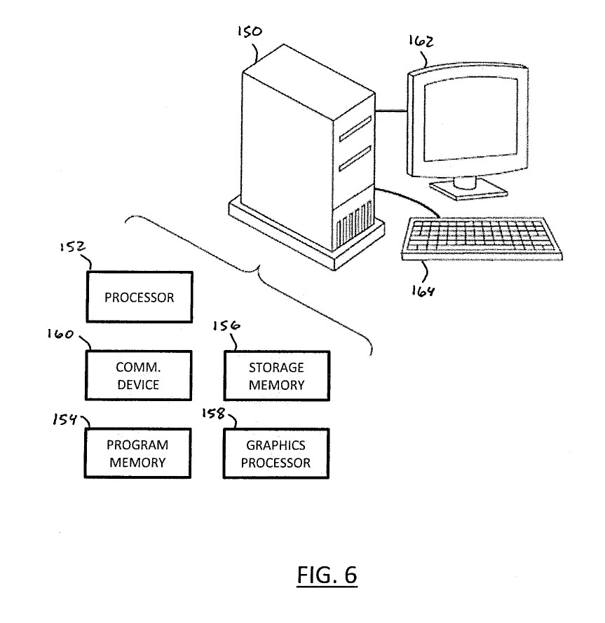

To aid the picker robot 10, there may be a connection through the communications system 15 and the control system 40 with a human operator who can selectively remotely control the functions of the picker robot 10 from a control station of the type shown in FIG. 6. Such remote control could be used to help the picker robot 10 maneuver or guide the one or more manipulators 12 in grasping and handling objects. At least some of the time, the picker robot 10 could be capable of autonomous actions as well. The picker robot 10 could use its communications system 15 to signal the human operator when the picker robot 10 needs assistance.

The human operator is likely located remote from the picker robot 10. For example, the operator could even be located in a different country. Alternatively, the human operator could be situated in the same warehouse as the picker robot, but at a different location. The human operator could sequentially connect with many different picker robots 10 in order to assist in tasks which are beyond the picker robot's autonomous capabilities. One advantage of this form of human interaction is that the labor cost of the human is spread across a plurality of picker robots 10. The human's role would be to quickly help a picker robot 10 perform difficult tasks while allowing the autonomous capability of the picker robot to perform the easier tasks.

The picker robot 10 is designed to safely operate around human workers. To this end, the environment sensing system 14 is capable of detecting humans and preventing the mobile base 13 from hitting people. The manipulators 12 are also safe for operation around people. Any physical contact between a picker robot 10 and a person would not result in the picker robot 10 actually injuring a person.

In an alternate embodiment, and with reference now to FIG. 2, a picker robot 20 can be provided with a vertical lift device 21 which is adapted to move one or more manipulators 12′ mounted to the lift device high enough to reach objects in storage locations which are beyond the reach of human workers. In one embodiment, the vertical lift device or system can employ a ratchet drive or a scissor lift. Alternatively, it can employ a hydraulically actuated telescoping tube. Each of these is known in the art.

The inclusion of the vertical lift device or mechanism 21 for the picker robot enables the picker robot 20 to reach objects and storage containers 50 that are located above the reach of people. In warehouses with unit load pallets, those pallets on shelves located higher than about six feet are usually beyond the reach of people. In some warehouses, the ceiling height can be 32 feet, much beyond the reach of people. Cases on these higher pallets cannot be accessed to make up or create mixed case pallets unless a forklift brings those unit load pallets to floor level. By providing access to unit load pallets located on higher shelves, the vertical lift mechanism 21 allows a larger number of product types to be stored in a smaller area. This reduces the cost of the warehouse and lowers the travel time of the picker robot 20 from one product type to another.

Warehouses are generally built with ceiling heights that are three to six times higher than the reach of a person. A distribution warehouse that uses storage containers 50 and picker robots 20 that are provided with a lift mechanism 21 can effectively use shelving that occupies the full height available in the warehouse. This represents a much more efficient use of the available volume. As with the first embodiment, the picker robot 20 is mobile. To this end, it is provided with wheels castors or other means 17 for allowing the base 13 to move.

A picker robot 20 with a vertical lift mechanism 21 may benefit from the provision of additional manipulators 12 which can grasp the shelf structure in order to stabilize the picker robot 20. Additional such manipulators (not illustrated) can be located on the mobile base 14 or on the vertical lift mechanism 21. Further, the shelves (not illustrated) on which cases or objects are stored may be equipped with special grasp points that simplify the stabilization task for the picker robot 20. As with the picker robot 10 of the first embodiment, the picker robot 20 is safe to operate around human beings. The environment sensing system 14 is capable of detecting people and preventing the mobile base 13 from hitting people. Further, the manipulators 12 and the vertical lift system 21 are also safe to operate around people. Any physical contact between the picker robot 20 and a person will not result in the picker robot 20 actively injuring a person.

According to one embodiment, the system can also include a carrier robot 30 onto which a picker robot, such as the robot 10 or the robot 20, can selectively place objects, products, storage containers 50 or packages and from which the picker robot can remove such objects, products, storage containers 50 or packages.

While the picker robots 10 and 20 can carry individual objects and storage containers 50 to a location where they are needed, it will often be more efficient to use a carrier robot 30 for this purpose. Similar to the picker robots illustrated, the carrier robot 30 includes a mobile base 31, an environment sensing system 34 and a communications system 35. Mobility for the carrier robot is provided by one or more wheels, castors or other means 37 for allowing the base 31 to move over a support surface, such as the floor. A carrier robot 30 is less expensive than a picker robot because it does not have the manipulators or the object sensing system employed on the picker robot. Moreover, a carrier robot 30 is less expensive than the picker robot 20 because in addition to not having manipulators and an object sensing system, it also does not have a vertical lift system.

The carrier robot 30 may, if desired, have a load container system 32 which helps align and stabilize a load. When the carrier robot is used to carry a mixed case pallet that is being built up, the load container system 32 may be effective in supporting and aligning the cases which are being stacked. The load container system 32 may be a purely passive mechanical device. In one embodiment, the load container system 32 is nothing more than a series of wall sections 38 which cooperate to form a generally U-shaped side wall mounted to the base 31. In this way, storage containers 50 or other products, packages or goods can be held on a top surface 39 of the mobile base 31. Alternatively, the load container system could include active components (not shown) which engage the load to provide additional alignment or stability.

In one embodiment, the carrier robot 30 can carry individual objects or storage containers 50. The picker robot (such as 10 or 20) can place objects and storage containers 50 onto the carrier robot 30 and can also remove objects and storage containers from the carrier robot.

As with the picker robots 10, 20, the carrier robot 30 is safe to operate around human beings. To this end, the environment sensing system 34 is capable of detecting people and preventing the mobile base 31 from hitting people. Any physical contact between the carrier robot 30 and a person will not result in the carrier robot actively injuring a person.

With reference now also to FIG. 4, the control system 40 can include a communication system 41 which is electronically connected to a robot controller 42. This, in turn, connects electronically to an existing warehouse inventory system 43. Two way communication between these systems is illustrated by arrows. The communications system 41 can connect the several picker robots 10 and/or 20 and the several carrier robots 30 in the warehouse to the robot controller 42.

The robot controller 42, in turn, commands the picker robots 10 and/or 20 and carrier robots 30 to maneuver to desired locations in order to retrieve objects held in storage containers 50 and/or to place objects in storage containers in a desired location. The robot controller 42 communicates with the warehouse inventory system 43 to determine what tasks need to be accomplished and at what locations. The robot controller 42 can also communicate with one or more human workers (not illustrated) who can remotely operate (see FIG. 6) any desired picker robot or carrier robot which needs assistance.

With reference now to FIG. 5, the storage container 50 can hold one or more items, objects or packages. These can all be of generally the same product type if so desired. In a distribution warehouse, a newly received case of products can be opened up and the cartons of that product, which can be packaged for individual sale, can be placed into a common storage container 50. Picker robots 10 and/or 20 and possibly carrier robots 30 can be used to transport that storage container to a storage location within the warehouse. When one or more of those product cartons are needed for a customer's order, picker robots 10 and/or 20 and possibly carrier robots 30 will retrieve the storage container 50 from a first or storage location and transport that container to a second location where one or more of the cartons will be removed from the storage container for packing and shipping to a customer. Thereafter, the storage container 50 can be returned by the picker robots 10 and/or 20 and possibly the carrier robot 30 to a desired storage location, which can be the first location or another location.

In one embodiment, the storage container 50 has identification features, as at 53, which enable each individual storage container to be uniquely identified by the picker robots 10 and/or 20. In one embodiment, such identification features include bar codes or Matrix codes (2 dimensional bar codes). In another embodiment, such identification features include radio frequency identification devices (RFIDs) or tags. Other known forms of identification can also be employed.

The grasping, lifting and/or placing of the storage containers 50 can be accomplished via remote control by a human operator employing a digital processing device 150 at a work station, one embodiment of which is shown in FIG. 6.

The storage container 50 can also be provided with one or more grasping features such as illustrated at 51. The grasping features allow the picker robots 10 and 20 to more easily grasp the storage container 50. As illustrated in FIG. 5, the grasping feature can be a handle portion of the storage container 50. Two such handle portions are shown in this embodiment, with each handle being grasped by a respective arm of the picker robot.

With reference to FIG. 6, the digital processing device 150 can employ any known central processing system. As illustrated, the digital processing device 150 is a computer which includes a processor 152, a program memory 154, a storage memory 156, a graphics processor 158, and one or more communication devices 160 that can be used by the human operator. The processor 152 (e.g., a central processing unit) executes processor executable instructions stored on the program memory 154 (e.g., random access memory (RAM)). These processor executable instructions can embody the central processing system. The storage memory 156 (e.g., a hard drive) provides mass storage to the processor 152, the graphics processor 158 renders graphical elements of a graphical user interface on a display device 162 (e.g., a computer monitor), and the communication device(s) 160 provide the processor 152 with interface(s) to external systems and/or devices, such as the robotic mobile devices 10, 20, 30 or user input devices 164 (e.g., a keyboard), over a communication network and/or data bus. As mentioned, the user input devices can be located remotely from the robotic mobile devices. It should be appreciated that the digital processing device150 communicates with the warehouse inventory system 43, as well as the robot controller 42. In one embodiment, the warehouse inventory system 43 is housed in the digital processing device 150.

The present disclosure details a mobile robot system that can move through a warehouse and retrieve items from storage. Depending on the application, the robot system is also capable of placing items into storage.

The robot system can include a fleet of mobile robotic devices. One such device can be a picker robot that autonomously goes to a first or storage location, for example to a shelf, and retrieves an object from that location. The storage location may contain a unit load pallet in which circumstance the picker robot will lift a package, bag or other object from the pallet and transport that object to a second location where it is needed. The grasping and lifting of the object may be fully autonomous or may be partially accomplished via remote control by a human operator.

The first or storage location may include several individual storage containers which can hold one or more items. In that instance, the picker robot will lift the storage container from the first location and transport the entire storage container to a second location where it is needed. The picker robot is also able to place storage containers in storage locations. The grasping, lifting and placing of the storage containers may be fully autonomous or it may be at least partially accomplished via remote control by a human operator. Each storage container can have special features that allow it to be easily recognized and grasped by the picker robot. In certain embodiments, the picker robot may have a vertical lift device that allows it to reach higher storage locations.

The fleet of mobile robotic devices can also include one or more carrier robots which can work in cooperation with one or more picker robots. In such cooperative work, a picker robot will put an object onto a carrier robot or pick up the object from the carrier robot. If the picker robot has placed an object on a carrier robot, that carrier robot might then go directly to the location where the object is needed. Alternatively, the carrier robot may continue to accumulate objects from one or more picker robots, potentially in order to build up a mixed case pallet on the carrier robot. The interaction between the carrier robot and the picker robot may be fully autonomous or it may be partially accomplished via remote control by a human operator.

The carrier robot and the picker robot can each be equipped with sensors which allow the robots to safely maneuver autonomously within the warehouse while human workers are present. The picker robot's one or more manipulators and mechanisms are adapted for safe operation near human workers.

In some embodiments, the sensor system of the robotic mobile device detects structures and objects within the robotic mobile device's surroundings and builds a three-dimensional representation of that environment. This computer model of the robotic mobile device's surroundings can then be used in such embodiments to create keep-out zones. The control software of the robotic mobile device can intercept the human operator's commands to the manipulator system. The commands are then analyzed to determine whether the commands would cause the manipulator to enter the keep-out zones. If a command would not cause the manipulator to enter the keep-out zones, the command is forwarded to the manipulator system. Otherwise, the command can be filtered. In this way, collisions between the manipulator and the surroundings can be prevented, which might otherwise result in damage to the robotic mobile device, or to the surroundings, or to both.

Several exemplary embodiments have been described herein. Obviously, modifications and alterations will occur to others upon reading and understanding the preceding detailed description. It is intended that the disclosure be construed as including all such modifications and alterations insofar as they come within the scope of the appended claims or the equivalents thereof.

1. A warehouse robotic system comprising:
a picker robot including a mobile base, an environment sensing system;
a communications system, at least one manipulator, an object sensing system;
a control system including a communications system, a robot controller, and a connection to an associated warehouse inventory system;
wherein the picker robot is adapted to maneuver to a first location, retrieve at least one associated object from the first location, transport the at least one associated object to a second location, and place the at least one associated object at the second location.

2. The system of claim 1 further comprising a vertical lift system mounted on the base, wherein the at least one manipulator is mounted to the vertical lift system.

3. The system of claim 1 wherein the environment sensing system communicates with a remote operator and provides the remote operator with situational awareness of the picker robot's surroundings.

4. The system of claim 1 wherein the picker robot is configured to be selectively remotely operated by a human operator via the communications system.

5. The system of claim 1 wherein the environment sensing system detects the surroundings of the picker robot and that sensor data is used to construct a representation of the environment, wherein the representation of the environment is used to prevent collisions of the picker robot with the environment including during remote operation commanded by a human operator.

6. A warehouse robotic system comprising:
a picker robot including a mobile base, an environment sensing system, a communications system, at least one manipulator, and an object sensing system;
a carrier robot including a mobile base, an environment sensing system, and a communications system;
a control system including a communications system, a robot controller and a connection to an associated warehouse inventory system;
wherein the picker robot is adapted to maneuver a first location, retrieve at least one associated object from the first location, place the at least one associated object onto the carrier robot, and wherein the carrier robot is adapted to transport the associated at least one object to a second location.

7. The system of claim 6 further comprising a vertical lift system mounted on the base of the picker robot wherein the at least one manipulator is mounted to the vertical lift system.

8. The system of claim 6 wherein the environment sensing system of the picker robot communicates with a remote operator and provides the remote operator with situational awareness of the picker robot's surroundings.

9. The system of claim 8 wherein the picker robot is configured to be selectively remotely operated by a human operator via the communications system of the picker robot.

10. The system of claim 6 wherein the carrier robot is configured to be selectively remotely operated by a human operator via the communication system of the carrier robot.

11. A warehouse robotic system comprising:
a picker robot including a mobile base, an environmental sensing system, a communications system, at least one manipulator, and an object sensing system;
a control system including a communications system, a robot controller and a connection to an associated warehouse inventory system;
a storage container with an identification feature;
wherein said picker robot is adapted to maneuver to a first location, identify the storage container, retrieve the storage container from the first location, transport the storage container to a second location, and place the storage container at the second location.

12. The system of claim 11 further comprising a vertical lift system mounted on the base of the picker robot wherein the at least one manipulator is mounted to the vertical lift system.

13. The system of claim 11 wherein the environment sensing system communicates with a remote operator and provides the remote operator with situational awareness of the picker robot's surroundings.

14. The system of claim 11 wherein the picker robot is configured to be selectively remotely operated by a human operator via the communications system.

15. The system of claim 11 wherein the storage container comprises a grasping feature which is adapted to be grasped by the at least one manipulator of the picker robot.

16. A warehouse robotic system comprising:
a picker robot including a mobile base, an environmental sensing system, a communications system, and at least one manipulator;
a carrier robot including a mobile base, an environmental sensing system, and a communications system;
a control system including a communications system, a robot controller, and a connection to an associated warehouse inventory system; and
a storage container;
wherein the picker robot is adapted to maneuver to a first location, retrieve the storage container from the first location, place the storage container on a carrier robot, the carrier robot is adapted to transport the storage container to a second location, and wherein the carrier robot is adapted to return the storage container to the picker robot which is adapted to place the storage container back at the first location.

17. The system of claim 16 further comprising a vertical lift system mounted to the base of the picker robot wherein the at least one manipulator is mounted to the vertical lift system.

18. The system of claim 16 wherein the environment sensing system of at least one of the picker robot and the carrier robot is configured to communicate with a remote operator and to provide the remote operator with situational awareness of the respective robot's surroundings.

19. The system of claim 16 wherein at least one of the picker robot and the carrier robot is configured to be selectively remotely operated by a human operator via the respective communications system of the respective robot.
